(19) United States
(12) Patent Application Publication
(10) Pub. No.: US 2001/0037291 A1
(43) Pub. Date: Nov. 1, 2001

(54) Internet based single entry field electronic payment interface

(76) Inventor: Dale F. Allen II, Ft.Worth, TX (US)

Correspondence Address: AKIN GUMP STRAUSS HAUER & FELD, 1900 FROST BANK PLAZA, 816 CONGRESS AVENUE, AUSTIN, TX, 78701

(21) Appl. No.: 09/809,708

(22) Filed: Mar. 15, 2001

Related U.S. Application Data
(60) Provisional application No. 60/190,161, filed on Mar. 17, 2000.

(51) Int. Cl. G06F 17/60

(52) U.S. Cl. 705/39

(57) ABSTRACT

An Internet based single entry field electronic payment interface. The invention allows for a single entry field to accommodate any number of various payments types for purchases via the Internet. Whereas traditional systems commonly accommodate only credit card transactions via the Internet, the invention allows for any number of payment types to be transacted through the common portal. In one embodiment, a selection is made to determine which payment type is to be used with the single entry field. Then, the payment information corresponding to that selection is provided to the single entry field to perform the financial transaction. The single entry field payment functionality is provided on a local sever that accommodates a merchant web site in one embodiment. Alternatively, a framed portion of the merchant web page facilitates the purchase, or a hyper-link to a payment web page is used in even other embodiments to perform the purchase.

### CROSS REFERENCE TO RELATED APPLICATIONS

The present application is based on and claims priority to U.S. Provisional Patent Application Ser. No. 60/190,161 entitled “AN INTERNET BROWSER BASED SOFTWARE INTERFACE ENABLING MULTIPLE FORMS OF PAYMENT WITH A SINGLE ENTRY FIELD,” (Attorney Docket No. N/A), filed Mar. 17, 2000. All of such application is hereby incorporated herein by reference in its entirety, including any drawings and appendices, and is made part of the present U.S. Patent Application for all purposes.

### BACKGROUND

1. Technical Field

The present invention relates generally to electronic payment systems; and, more particularly, it relates to a system that provides for multiple electronic payment types via a common electronic payment portal on the Internet.

2. Related Art

On the Internet, credit card payments are conventionally the payment method of choice due primarily to their wide use, acceptance, and their ability to be processed electronically. For proper electronic payment processing of such financial transactions, an interface had to be generated to forward pertinent credit card information from a merchant's web site to a credit card processor site where the transaction would be processed. Today, credit cards are almost the exclusive means by which merchant's accept online payments on the Internet.

Electronic wallets have been developed to allow for more facilitated entry of credit card and personal payment information. The electronic wallet allows for customers to enter all of this payment information once instead of repeatedly at each web site at which they choose to make purchases. The use of the electronic wallet inherently requires that each and every merchant web site to comply strictly with the standards set forth in the electronic wallet protocol by either ensuring that its web site employs the electronic wallet or performs the necessary transformation to accommodate the electronic wallet information as it is received. The inflexibility of such a system is evident in that each and every merchant must comply with the electronic wallet protocols and standards and upgrading or modifying these protocols and standards is radically cumbersome as each and every participating merchant must accommodate any changes in the protocols and standards format.

Moreover, some merchants choose not to comply with the electronic wallet format and rather choose to perform a proprietary payment methodology. This can further frustrate customers on the Internet as it may seem that various merchants choose to provide for radically different and independent credit card payment functionality. It can seem to be a new investigation and challenge each time that a customer seeks to perform purchase from various merchants at their independently run web sites.

Further limitations and disadvantages of conventional and traditional systems will become apparent to one of skill in the art through comparison of such systems with the present invention as set forth in the remainder of the present application with reference to the drawings.

### SUMMARY OF THE INVENTION

Various aspects of the present invention can be found in an electronic payment interface. The electronic payment interface includes a number of payment types, a single entry field, and help and formatting information. Each of the number of payment types is selectable using a drop box. The single entry field that is operable to accommodate each of the number of payment types to perform a financial transaction. The single entry field receives payment information corresponding to a selected one of the number of payment types in a predetermined format. The help and formatting information is displayed near the single entry field, and it indicates a proper format for entry of the payment information into the single entry field.

In certain embodiments of the invention, the electronic payment interface is hosted on an Internet server. The electronic payment interface also includes interactive help that is accessible via the electronic payment interface. The electronic payment interface also includes a proceed button that is operable to continue the financial transaction, and a cancel button that is operable to cancel the financial transaction. The electronic payment interface is capable to be accessed from a merchant's point of sale. The electronic payment interface also includes a payment processor, communicatively coupled to the single entry field, that processes the payment information in completing the financial transaction. The payment processor is communicatively coupled to a remote server. The financial transaction performs electronic funds transfer to a merchant bank.

Other aspects of the present invention can be found in an Internet based single entry field electronic payment interface. The Internet based single entry field electronic payment interface includes a number of payment types and a single entry field. The single entry field that is operable to accommodate each of the number of payment types to perform a financial transaction. The single entry field receives payment information corresponding to at least one of the number of payment types in a predetermined format.

In certain embodiments of the invention, the Internet based single entry field electronic payment interface also includes a payment processor that processes the payment information during the financial transaction. The Internet based single entry field electronic payment interface may also include at least one additional payment processor. Payment processing is then distributed, at least in part, between the payment processor and the at least one additional payment processor. The payment processor is communicatively coupled to a remote server. The payment processor is communicatively coupled to a merchant bank. In various embodiments of the invention, the Internet based single entry field electronic payment interface also includes a remote server, and the remote server receives the payment information via the Internet. The number of payment types includes credit card, check debit, ATM card, and electronic money order, among other payment types.

Other aspects of the present invention can be found in an electronic payment method. The electronic payment method includes selecting a payment type, and inputting payment information corresponding to the selected payment type into a single entry field. The single entry field is operable to receive a number of various payment types.

In certain embodiments of the invention, the selection of the payment type includes selecting the payment from a predetermined list of payment types selectable using a drop box. The electronic payment method also includes payment processing using a payment processor. The payment processor being communicatively coupled to the single entry field. The electronic payment method also includes performing at least one of remote payment processing and local payment processing. The selection of the payment type enables the single entry field to receive one of the number of payment types, and the electronic payment method also includes providing help information indicative of a proper input format of the payment information.

Other aspects, advantages and novel features of the present invention will become apparent from the following detailed description of the invention when considered in conjunction with the accompanying drawings.

### BRIEF DESCRIPTION OF THE DRAWINGS

A better understanding of the present invention can be obtained when the following detailed description of various exemplary embodiments is considered in conjunction with the following drawings.

FIG. 1 is a system diagram illustrating an embodiment of an electronic payment system built in accordance with the present invention.

FIG. 2 is a system diagram illustrating another embodiment of an electronic payment system built in accordance with the present invention.

FIG. 3A is a system diagram illustrating an embodiment of an integrated payment interface built in accordance with the present invention.

FIG. 3B is a system diagram illustrating an embodiment of a linked payment interface built in accordance with the present invention.

FIG. 3C is a system diagram illustrating an embodiment of a framed payment interface built in accordance with the present invention.

FIG. 4 is a system diagram illustrating an embodiment of a payment interface built in accordance with the present invention.

FIG. 5 is a system diagram illustrating an embodiment of a virtual payment interface built in accordance with the present invention.

FIG. 6 is a functional block diagram illustrating an embodiment of an electronic payment method performed in accordance with the present invention.

FIG. 7 is a system diagram illustrating an embodiment of an electronic payment interface arranged in accordance with the present invention.

### DETAILED DESCRIPTION OF THE INVENTION

The present invention employs a VIRTUAL MONEY™ program having a trademark that has been duly filed for registration with the United States Patent and Trademark Office. The VIRTUAL MONEY™ program and its associated trademark have ownership that is common to the present patent application.

Trademark: VIRTUAL MONEY

Class: 9 & 36

Attorney Dkt.: 044966.0002

Ser. No.: 75/845,018

Filed: Nov. 29, 1999

Goods: “computer software that facilitates payments over a global computer network” in International Class 9

Services: “bill payment services via a global computer network” in International Class 36

The present invention also employs functionality described by a VIRTUAL CHECK™ trademark that has been duly filed for registration with the United States Patent and Trademark Office. The functionality associated with the VIRTUAL CHECK™ trademark has ownership that is common to the present patent application.

Trademark: VIRTUAL CHECK

Class: 9 & 36

Attorney Dkt.: 044966.0004

Ser. No.: 75/926,476

Filed: Jan. 28, 1999

Goods: “computer software for facilitating the payment for goods and services” in International Class 9

Services: “bill payment services via a global computer network” in International Class 36

The present invention also employs functionality described by a EVERYTHING YOU WANT™ trademark that has been duly filed for registration with the United States Patent and Trademark Office. The functionality associated with the EVERYTHING YOU WANT™ trademark have ownership that is common to the present patent application.

Mark: EVERYTHING YOU WANT

Class: 9 & 36

Attorney Dkt.: 044966.0003

Ser. No.: 78/004,168

Filed: Apr. 14, 2000

Goods: “computer software for facilitating payments for goods and services over a global computer network” in International Class 9

Services: “bill payment services via a global computer network” in International Class 36

The present invention provides for any number of various methods of payment via a common portal that is accessible via the Internet. Many consumers and customers do not possess credit cards, and subsequently, there is a customer and consumer base that cannot be tapped by many merchants who sell products via the Internet. As credit card payment is the only predominant method of payment via the Internet, those customers and consumers who do not have this type of payment ability cannot access these electronic markets via the Internet.

The present invention allows for the capture of the exponential growth within the Internet context giving customers and consumers the same ease of purchase that they presently enjoy at physical establishments. The present invention allows for the use of any number of the various payments types that are presently allowed at physical establishments also to be used via electronic payments from merchants' web sites. The advantages of such a system are many including the ease and convenience of customers being able to perform purchases using any of the various forms of payment currently used in the physical domain. The virtual money transfer as performed within the various embodiments of the present invention include those

The single entry field offered within the present invention makes it much easier for merchants to implement and also makes it much easier for buyers to use. The interface includes, among other things, payment type selection and a single entry field for the appropriate payment information that would be required depending on the payment type selected. In one embodiment, example and description lines are displayed for the payment type selected with the required format and error checking. Moreover, a comprehensive help option is also available for the specific type of payment type selected.

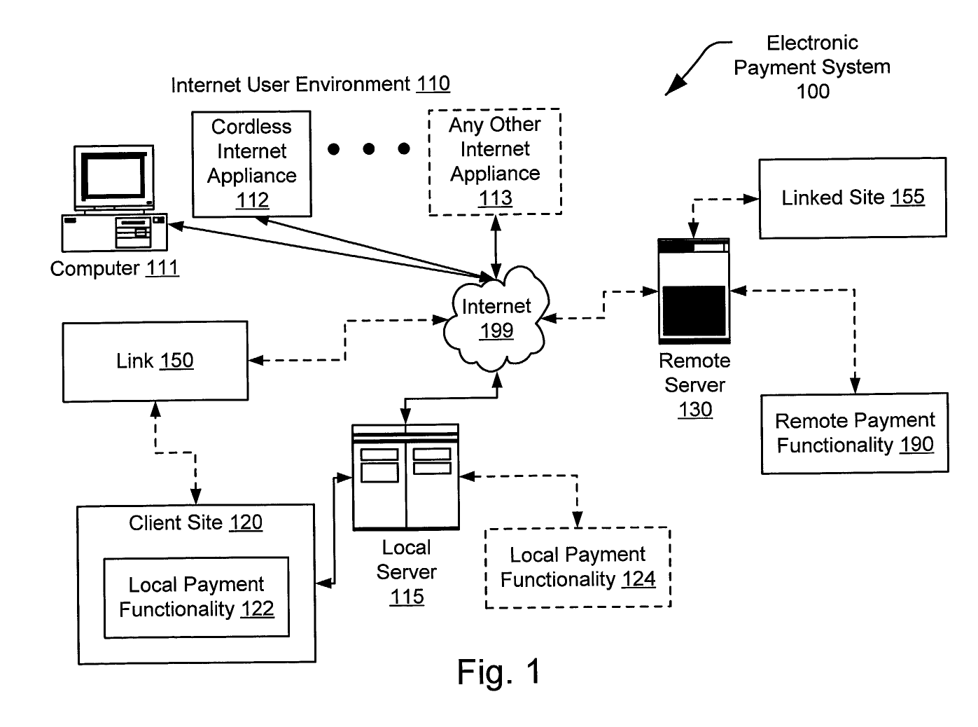

FIG. 1 is a system diagram illustrating an embodiment of an electronic payment system 100 built in accordance with the present invention. The electronic payment system 100 allows any device within an Internet user environment 110 to access the Internet 199. Any number of devices within the Internet user environment 110 are operable to access the Internet 199 including a computer 111, a cordless Internet appliance 112, or any other Internet appliance 113. After accessing the Internet 199, the user within the Internet user environment 110 accesses a client site 120 that is supported by a local server 115 and seeks to perform a financial transaction.

In certain embodiments of the invention, the financial transaction is performed locally using local payment functionality 122 by the client site 120. If desired, the local payment functionality 122 is supported on the local server within the client site 120. Alternatively, local payment functionality 124 is supported in a logically partitioned portion within the local server 115. Within various embodiments of the present invention as will be shown below, payment functionality is operable as being supported on a single processor; it is capable to be distributed among multiple processors; it is capable to be distributed in various locations on a single processor. From certain perspectives, the processor that supports the payment functionality is viewed as being a server, such as the local server 115.

In various embodiments of the invention, payment functionality is proffered by a link 150 to a linked site 155. The link 150 to the linked site 155 is available from the client site 120. The linked site 150 is accessed a remote server 130 supports the linked site 155. For embodiments of the present invention where the payment functionality is supported remotely, a remote functionality 190 is supported by the remote server 130. As within the embodiment where the payment functionality is supported with one of the local payment functionality 122 and 124, the remote payment functionality 190 may be supported within a portion of the remote server 130 that supports the linked site 155 or within another portion of the remote server.

The FIG. 1 shows a number of variations of the payment functionality being supported by locally or remotely. If desired, the payment functionality is distributed, at least in part, between both the local server 115 and the remote server 130. That is to say, a portion of the payment processing is performed using the local server 115 and a portion is performed using the remote server 130.

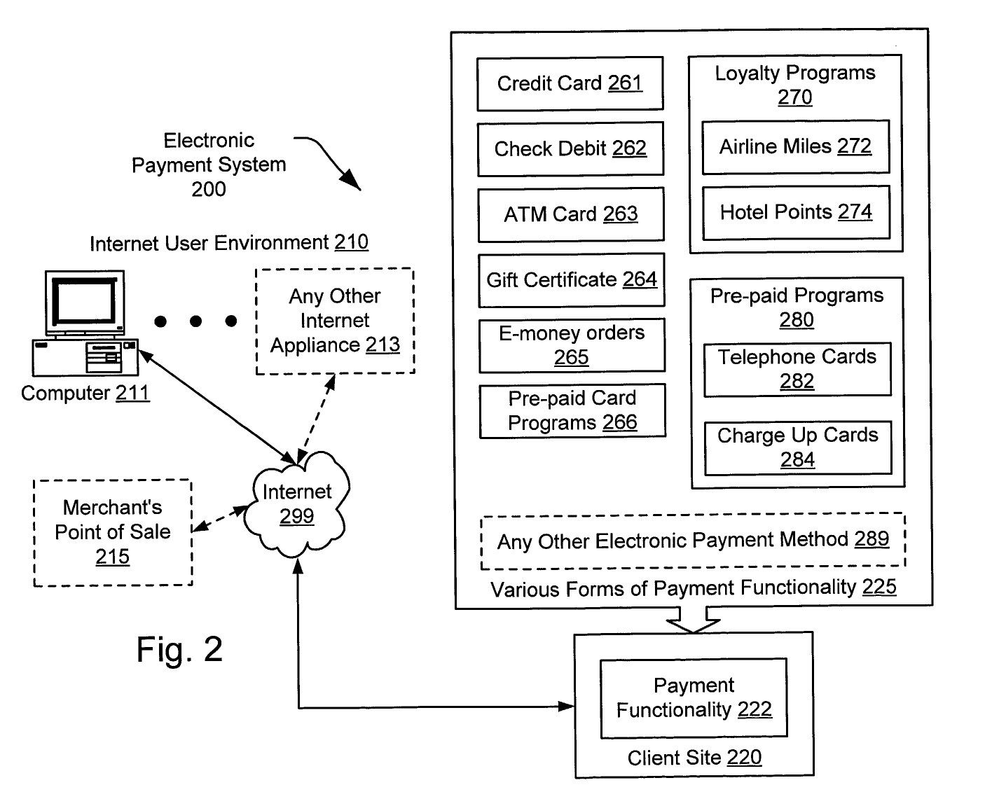

FIG. 2 is a system diagram illustrating another embodiment of an electronic payment system 200 built in accordance with the present invention. The electronic payment system 200 allows any device within an Internet user environment 210 to access the Internet 299. Any number of devices within the Internet user environment 210 are operable to access the Internet 299 including a computer 211 or any other Internet appliance 213. Alternatively, a merchant's point of sale 215 is operable to access the Internet in various embodiments of the invention. In such merchant interactive situations, any device, including the computer 211 or the any other Internet appliance 213, may be located at a merchant's physical location and the Internet 299 is then accessed at the point of sale to perform the financial transaction. After accessing the Internet 299, the user within the Internet user environment 210 accesses a client site 220 that supports payment functionality 222.

The present invention provides for any number of various types and methods of payments. Examples of various types of payment functionality 225 include any number of payment methods that may be performed electronically. For example, the various types of payment functionality 225 includes payment using a credit card 261, check debit 262, an automatic teller machine (ATM) card 263, a gift certificate 264, electronic (E-money) orders 265, pre-paid card programs 266. In addition, any number of loyalty programs 270 and pre-paid programs 280 are operable in accordance with the present invention. Examples of loyalty programs 270 include programs such as airline miles 272 and hotel points 274. Examples of prepaid programs 280 include programs that use items such as telephone cards 282 and charge up cards 284. In addition, any other electronic payment method 289 may be used to support the payment functionality 222.

In certain embodiments of the invention, a single entry field is used to support each of the various forms of payment functionality 225. For example, once indicia is received by the electronic payment system 200 of which type of payment is to be used, the single entry field is then operable to receive the appropriate payment information to perform the financial transaction.

Within both of the electronic payment system 100 of the FIG. 1 and the electronic payment system 200 of the FIG. 2, the access of the payment functionality may be performed via a browsing user of the Internet or via a device resident at a merchant's physical location. That is to say, to finalize a financial transaction at a merchant's physical location, the merchant need only have a point of sale device that is operable to access the Internet to be able to perform the financial transaction.

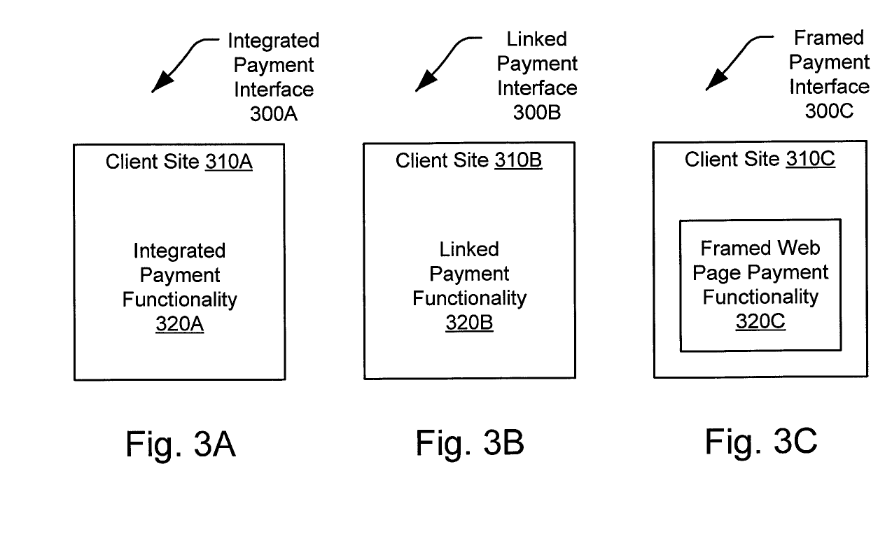

FIG. 3A is a system diagram illustrating an embodiment of an integrated payment interface 300A built in accordance with the present invention. The integrated payment interface 300A employs a client site 310A. The client site 310A offers integrated payment functionality 320A.

FIG. 3B is a system diagram illustrating an embodiment of a linked payment interface 300B built in accordance with the present invention. The linked payment interface 300B employs a client site 310B. The client site 310B offers linked payment functionality 320B.

FIG. 3C is a system diagram illustrating an embodiment of a framed payment interface 300C built in accordance with the present invention. The framed payment interface 300C employs a client site 310C. The client site 310C offers framed web page payment functionality 320C.

Each of the various embodiments of the present invention as shown in the FIG. 3A, 3B, and 3C allow for permutations of the payment interface. The payment interface may be supported locally via the integrated payment functionality 320A of the FIG. 3A; it may be supported remotely via the linked payment functionality 320B of the FIG. 3B where a user links to the remote site to perform payment processing. Alternatively, the payment interface may be supported, in real time, via framed web page payment functionality 320C where a portion of a remote web page is supported in real time and displayed on the client site 310C.

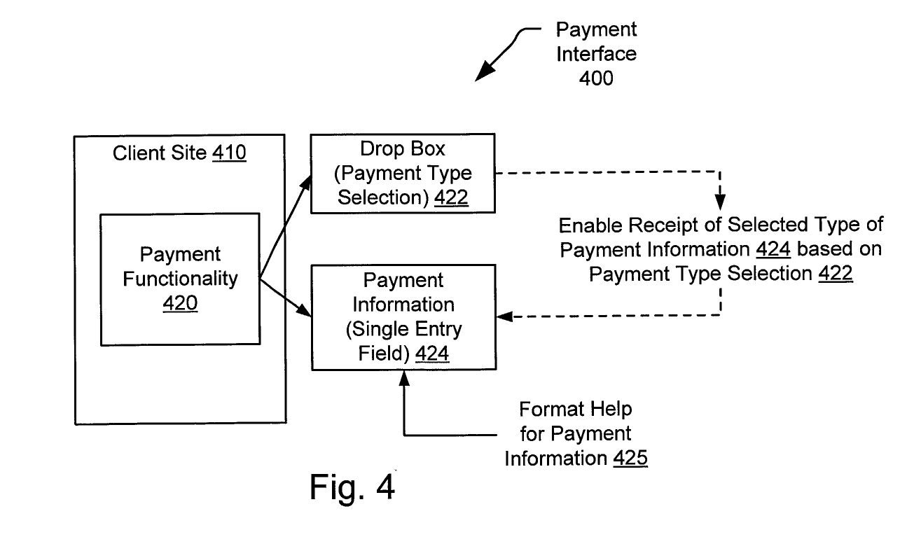

FIG. 4 is a system diagram illustrating an embodiment of a payment interface 400 built in accordance with the present invention. A client site 410 provides for payment functionality 420 using any of the various embodiments of payment functionality shown above and below. The payment functionality 420 employs a drop box in which payment type selection is made 422. There exists a finite number of selectable options within the drop box (payment type selection) 422 from which the payment type may be selected.

Then, depending on the payment type that is selected in the drop box 422, payment information 424 is provided within a single entry field that is operable to accommodate any of the various payment types that are selectable in the drop box 422. That is to say, the selection within the drop box (payment type selection) 422 enables receipt of a selected type of payment information 424 within a single entry field.

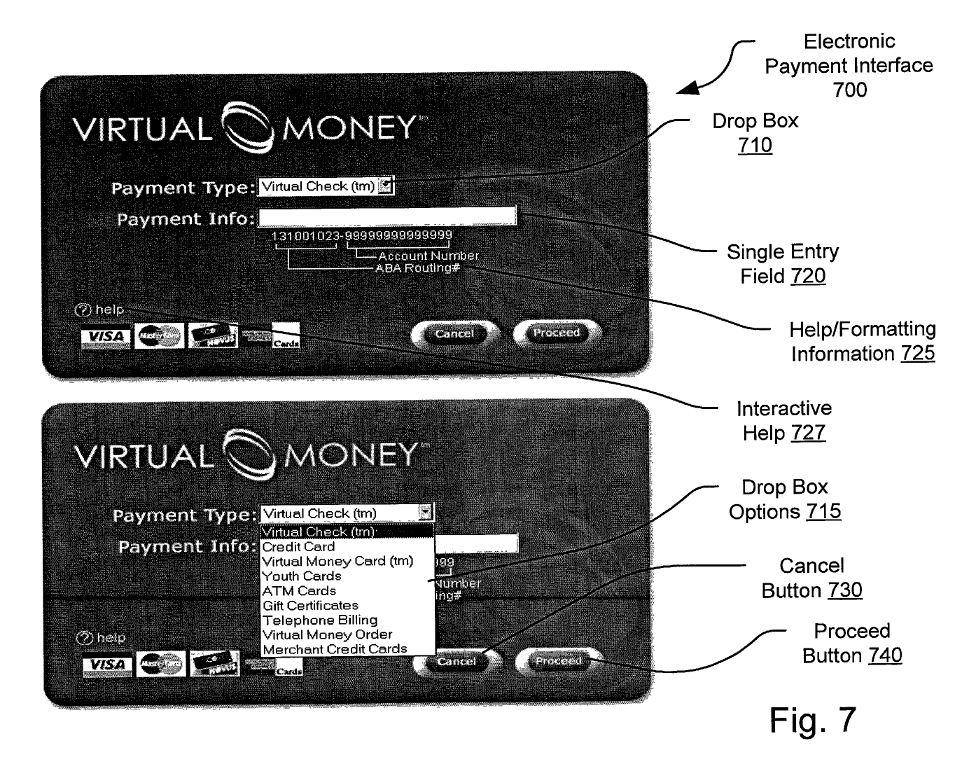

If desired in various embodiments of the invention, format help for payment information 425 is also provided to assist a purchaser to input his information in a particular format. One embodiment of the manner in which payment information is input into the single entry field is shown below in the FIG. 7. Other information formats are envisioned as well without departing from the scope and spirit of the invention.

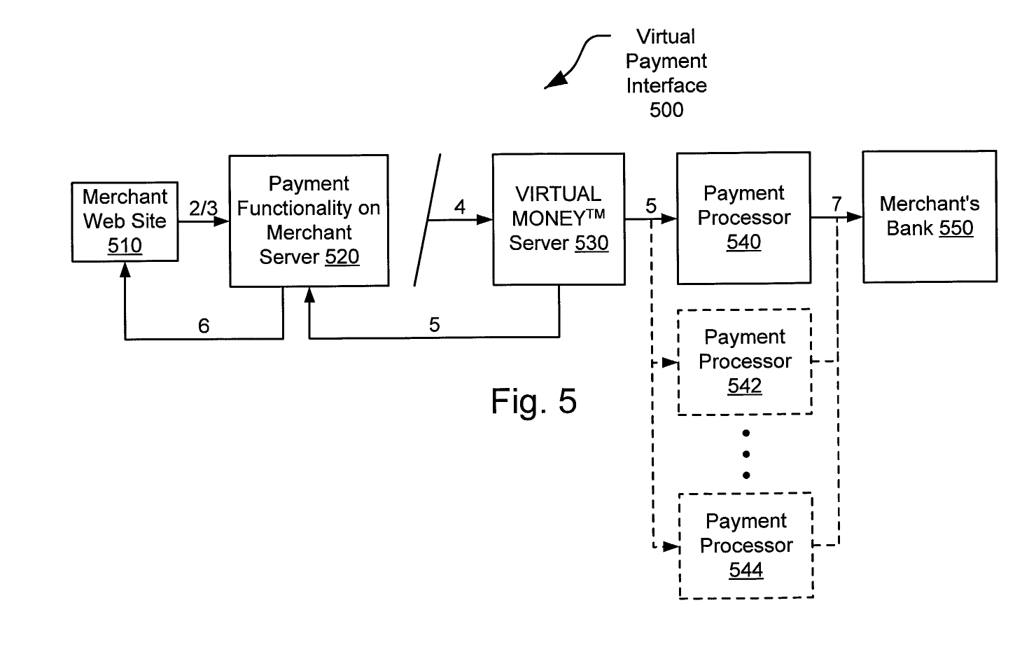

FIG. 5 is a system diagram illustrating an embodiment of a virtual payment interface 500 built in accordance with the present invention. On a merchant web site 510, a purchaser shops for and selects items to be purchased.

Then, as shown by an arrow 2, the purchaser provides name and shipping information and is then presented with payment functionality on a merchant server 520. The merchant server 520 employs a VIRTUAL MONEY™ interface in certain embodiments of the invention. The purchaser selects the method of payment from the payment functionality on a merchant server 520 and enters the appropriate payment information. Some examples of various types of payment information are shown as in the FIG. 2, among other types of payment information. A single entry field is used for the entry of any number of various types of payment information.

Then, as shown by an arrow 3, a purchaser is able to consummate the financial transaction. In one embodiment, a “proceed” button enables the purchaser to continue on with his financial transaction.

Then, as shown by an arrow 4, the payment information using the payment functionality supported on the merchant server 520 is then transmitted to a VIRTUAL MONEY™ server 530. The VIRTUAL MONEY™ server 530 is viewed as being a remote server as shown in various embodiments of the invention. The payment information is then passed to a payment processor 540.

Then, as shown by an arrow 5, the payment information is captured, and the transaction is routed in a required format to the appropriate payment processor 540. The payment processor 540 is operable to accommodate any number of various payment types. Alternatively, different payment processors are used to accommodate the various payment types as shown by the payment processors 542, . . . , and 544. In addition, this information is also passed back to the merchant server 520 as shown by another arrow 5 going from the VIRTUAL MONEY™ server 530.

Then, as shown by an arrow 6, the merchant server 520 informs the purchaser whether the financial transaction is approved or not. Ultimately, as shown by an arrow 7, the funds for the purchase are electronically transferred to the merchant's bank 550.

The embodiment of the present invention shown in the FIG. 5 is illustrative of an embodiment where a remote server (the VIRTUAL MONEY™ server 530) performs the financial transacting for a merchant server. Also, as shown above in various embodiments of the invention, the particular manner is which the remote server (the VIRTUAL MONEY™ server 530) is tied to the merchant server 520 is performed in any number of different ways including linking and framing.

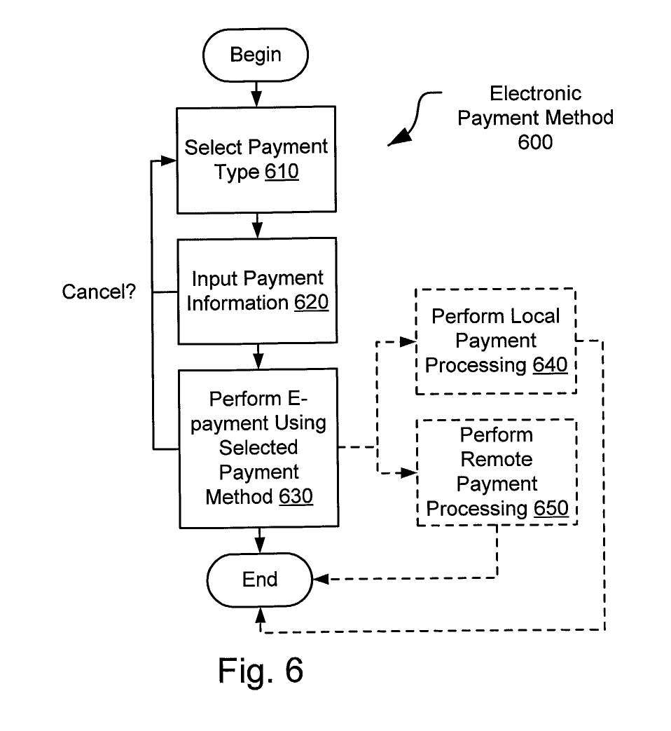

FIG. 6 is a functional block diagram illustrating an embodiment of an electronic payment method 600 performed in accordance with the present invention. In a block 610, a payment type is selected. Then, in a block 620, payment information is input. If improper payment is accidentally input in the block 620 or if a user wishes to abort the payment process, a cancel operation may be selected to cancel the operation. Then, in a block 630, an E-payment (electronic payment) is performed using the payment method previously selected.

In certain embodiments of the invention, payment processing is performed in any number of different ways. In one embodiment, payment processing is performed locally in an alternative block 640 before the electronic payment method 600 terminates. In others, payment processing is performed remotely in an alternative block 650 before the electronic payment method 600 terminates.

FIG. 7 is a system diagram illustrating an embodiment of an electronic payment interface 700 arranged in accordance with the present invention. The electronic payment interface 700 is illustrative of just one embodiment of payment where a drop box 710 provides for a user to select any number of drop box options 715. In the illustrated embodiment, the drop box options 715 include VIRTUAL CHECK™, Credit Card, VIRTUAL MONEY CARD™, Youth Cards, ATM Cards, Gift Certificates, Telephone Billing, VIRTUAL MONEY ORDER, and Merchant Credit Cards. Clearly, any other number of options may be included within the drop box options 715 without departing from the scope and spirit of the invention.

A single entry field 720 is then enabled to receive the particular type of payment information corresponding to the payment option selected by the drop box 710. If desired, help/formatting information 725 is provided near the single entry field 720 to assist a user in properly entering the payment information into the single entry field 720. Moreover, interactive help 727 is also proffered within the electronic payment interface 700.

When the proper payment type has been selected within the drop box 710 and the proper payment information, in the proper format, has been entered within the single entry field 720, a user is given the opportunity to consummate the financial transaction using a proceed button 740. The user is also provided the opportunity to cancel the transaction, using a cancel button 740, for any reason.

The electronic payment interface 700 of the FIG. 7 shows an embodiment of a single entry field 720 that is able to accommodate any number of various payment types and provides a radically simplistic user interface. A user of the electronic payment interface 700 is a customer in certain embodiments of the invention; in others, a merchant is the user who employs the electronic payment interface 700 at a point of sale site whereby customers of the merchant pay for conferred goods and/or services at a physical site. Alternatively, the user is an individual performing Internet browsing in even other embodiments. The present invention is operable to perform electronic payment (E-payment) within any number of contexts. In fact, the present invention is operable to accommodate any type of financial transaction that may be performed via electronic means.

In view of the above detailed description of the present invention and associated drawings, other modifications and variations will now become apparent to those skilled in the art. It should also be apparent that such other modifications and variations may be effected without departing from the spirit and scope of the present invention.

What is claimed is:

1. An electronic payment interface, comprising:
a plurality of payment types, each of the plurality of payment types is selectable using a drop box; and
a single entry field that is operable to accommodate each of the plurality of payment types to perform a financial transaction, the single entry field receives payment information corresponding to a selected one of the plurality of payment types in a predetermined format; and
help and formatting information, displayed near the single entry field, that indicates a proper format for entry of the payment information into the single entry field.

2. The electronic payment interface of claim 1, wherein the electronic payment interface is hosted on an Internet server.

3. The electronic payment interface of claim 1, further comprising interactive help that is accessible via the electronic payment interface.

4. The electronic payment interface of claim 1, further comprising:
a proceed button that is operable to continue the financial transaction; and
a cancel button that is operable to cancel the financial transaction.

5. The electronic payment interface of claim 1, wherein the electronic payment interface is accessed from a merchant's point of sale.

6. The electronic payment interface of claim 1, further comprising a payment processor, communicatively coupled to the single entry field, that processes the payment information in completing the financial transaction.

7. The electronic payment interface of claim 6, wherein the payment processor is communicatively coupled to a remote server.

8. The electronic payment interface of claim 1, wherein the financial transaction performs electronic funds transfer to a merchant bank.

9. An Internet based single entry field electronic payment interface, comprising:
a plurality of payment types;
a single entry field that is operable to accommodate each of the plurality of payment types to perform a financial transaction; and
the single entry field receives payment information corresponding to at least one of the plurality of payment types in a predetermined format.

10. The Internet based single entry field electronic payment interface of claim 9, further comprising a payment processor that processes the payment information during the financial transaction.

11. The Internet based single entry field electronic payment interface of claim 10, further comprising at least one additional payment processor; and
payment processing is distributed, at least in part, between the payment processor and the at least one additional payment processor.

12. The Internet based single entry field electronic payment interface of claim 10, wherein the payment processor is communicatively coupled to a remote server.

13. The Internet based single entry field electronic payment interface of claim 10, wherein the payment processor is communicatively coupled to a merchant bank.

14. The Internet based single entry field electronic payment interface of claim 9, further comprising a remote server; and
the remote server receives the payment information via the Internet.

15. The Internet based single entry field electronic payment interface of claim 9, wherein the plurality of payment types comprises at least one of credit card, check debit, ATM card, and electronic money order.

16. An electronic payment method, comprising:
selecting a payment type; and
inputting payment information corresponding to the selected payment type into a single entry field;
wherein the single entry field is operable to receive a plurality of payment types.

17. The method of claim 16, wherein the selecting the payment type comprises selecting the payment from a predetermined list of payment types selectable using a drop box.

18. The method of claim 16, further comprising:
payment processing using a payment processor; and
wherein the payment processor being communicatively coupled to the single entry field.

19. The method of claim 16, further comprising:
performing at least one of remote payment processing and local payment processing.

20. The method of claim 16, wherein the selection of the payment type enables the single entry field to receive one of the plurality of payment types; and
further comprising providing help information indicative of a proper input format of the payment information.
